(19) United States
(12) Patent Application Publication
(10) Pub. No.: US 2016/0098734 A1
(43) Pub. Date: Apr. 7, 2016

(54) A PERSONAL DATA INTEGRATION AND MANAGEMENT SYSTEM AND A METHOD THEREOF

(71) Applicant: Yen-Ju CHOU, Taiwan (CN)

(72) Inventor: Yen-Ju CHOU, Taichung City (TW)

(21) Appl. No.: 14/889,249

(22) PCT Filed: May 6, 2013
(86) PCT No.: PCT/CN2013/075211

§ 371 Date: Nov. 5, 2015

(51) Int. Cl. G06Q 30/02; G06F 21/62

(52) U.S. Cl. CPC G06Q 30/0201; G06F 21/6245

(57) ABSTRACT

The present disclosure relates to a personal data integration and management system and a method thereof wherein the system comprises a personal data processing and analysis application platform and a behavior recording and information request platform, both of which are connected to each other: the personal data processing and analysis application platform divides members' personal data into personal information and other reference information; the behavior recording and information request platform based on a signature of one member who initiates his/her action logins the personal data processing and analysis application platform to access other reference information as well as behavior information, configuring analysis-related conditions by which the personal data processing and analysis application platform enables statistics and analyses, transmitting analyzed data to the behavior recording and information request platform that delivers the analyzed data and other derived data to any predetermined demander.

### BACKGROUND OF THE INVENTION

1. Field of the Invention

The present disclosure relates to a personal data integration and management system and a method thereof, particularly a system and a method thereof by which information unrelated to recognizing an individual's identity is separated from personal data and incorporated into behavior information for consumer behavior analyses and employed by an enterprise, an organization or a research unit without risk of disclosing an individual's identity.

2. Description of Related Art

In general, the purpose to collect personal information is to make behavior information analyses for effective applications, particularly the consumer behavior analysis as an example well known to the general public and explained hereinafter.

To familiarize consumers with product information or promotion activities of a store, the ordinary commercial consumption model of a store includes distribution of mail advertising (DM), newspaper advertising or online classified advertising by which discount information of merchandises available in a store can be delivered to real potential consumers immediately and correctly for increased sales performance and real earnings. The marketing model, however, may go against advertising benefits because it probably fails to control real potential consumer groups correctly or send advertising information to the groups actively.

Against this background, some enterprises, organizations or research units initiated consumer behavior studies and analyses to collect consumers' consuming intentions and habits by questionnaires, polls, stocktaking, or consumption records based on membership cards. As the most common method, the questionnaire survey for pedestrians or the online questionnaire survey is to analyze collected questionnaires and determine consumers' consuming behaviors and trends. However, the questionnaire survey is questionable when personal information for a questionnaire may be incorrect or deliberately wrong because of consumers' concerns about disclosure of personal information. Therefore, the pre-analyses of consumer behaviors based on wrong information do not match realistic consumer behaviors.

Generally, a membership card issued by an enterprise or an organization can be used to collect a consumer's personal consuming habits for marketing purposes or product development based on consumers' preferences. In the course of collecting and analyzing consumers' personal consuming habits, enormous unnecessary personal information may be accumulated or transmitted in an enterprise or an organization from which the risk to disclose the personal information is increased.

To effectively analyze personal behavior information, correctly forecast specific personal demands and prevent personal identity information from disclosure, a personal data integration and management system and a method thereof presented by the patent applicant is an optimal solution to filter and classify members' personal data, separate information unrelated to recognizing an individual's identity for an enterprise, an organization or a research unit which refer to both the separated information as well as personal behavior information for systematical statistic analyses and relies on analyzed variables to collect data and make configurations for follow-up academic or commercial applications and protection of personal information security of an individual, an enterprise or an organization.

### SUMMARY OF THE INVENTION

The present disclosure relates to a personal data integration and management system and a method thereof comprising: a personal data processing and analysis application platform; a behavior recording and information request platform linking the personal data processing and analysis application platform. The personal data processing and analysis application platform comprises: a central processing module which regulates and controls operations of the personal data processing and analysis application platform; a database module which links the central processing module and stores member-related information in a member account; a member application and login module which links the central processing module and the database module, is employed by a member to login the personal data processing and analysis application platform, enter personal data and apply for a member account, provides the member with a Unique User ID (UUID), and stores personal data in a member account in the database module; an information separation module linking the central processing module and the database module and separating personal data into at least two types of information, personal information and other reference information, which is controlled according to different access privileges; a behavior analysis module which links the central processing module and the database module and conducts statistic analyses of other reference information and behavior information related to a member account in the database module for delivery of the analyzed information to a report module in the behavior recording and information request platform; an information delivery module which links the central processing module and the database module and sends appropriate information to a demander. The behavior recording and information request platform, which links the personal data processing and analysis application platform, comprises: a signature module which allows the behavior recording and information request platform to login the personal data processing and analysis application platform by a secure signature; a data transmission module which links the signature module as well as the database module in the personal data processing and analysis application platform and is used in transmitting a member's behavior information to a member account in the database module for storage when the behavior information with a UUID integrated is recognized by the signature module; an analysis condition setup module which links the signature module and the behavior analysis module and is used in selecting relevant variables and scopes and configuring analysis-related conditions when the personal data processing and analysis application platform is login according to a secure signature; a report module which links the behavior analysis module, receives analyzed information from the behavior analysis module, and outputs a report with analyzed information transformed; an information configuration module which links the information delivery module and is used in deciding a category of an information demander and preparing information for delivery of the information to a member who has agreed to receive information in advance through the information delivery module.

The personal data integration and management system and a method thereof in the present disclosure is capable of filtering and classifying added personal data of a member and separating unidentifiable personal data or behavior information which is further analyzed and employed by an enterprise, an organization or a research unit for academic purposes or commercial applications in the future.

The personal data integration and management system and a method thereof, which are based on a UUID mechanism for extended applications related to specific membership records, for example, organization staff cards, transaction documents or e-books, allow an authorized organization to access personal information or non-personal information with limited accessibility directly by consent of a member for effective information employment and personal information security.

In the personal data integration and management system and a method thereof for the above purposes, the personal data integration and management system, which is used in management and application of a member's personal data, comprises a personal data processing and analysis application platform as as a behavior recording and information request platform. The personal data processing and analysis application platform, which links the behavior recording and information request platform, comprises: a central processing module which regulates and controls operations of the personal data processing and analysis application platform; a database module which links the central processing module and stores member-related information in a member account; a member application and login module which links the central processing module and the database module, is employed by a member to login the personal data processing and analysis application platform, enter personal data and apply for a member account, provides the member with a Unique User ID (UUID), and stores personal data in a member account in the database module; an information separation module linking the central processing module and the database module and separating personal data into at least two types of information, personal information and other reference information, which is controlled according to different access privileges; a behavior analysis module which links the central processing module and the database module and conducts statistic analyses of other reference information and behavior information related to a member account in the database module for delivery of the analyzed information to a report module in the behavior recording and information request platform; an information delivery module which links the central processing module and the database module and sends appropriate information to a demander.

The behavior recording and information request platform, which links the personal data processing and analysis application platform, comprises: a signature module which allows the behavior recording and information request platform to login the personal data processing and analysis application platform by a secure signature; a data transmission module which links the signature module as well as the database module in the personal data processing and analysis application platform and is used in transmitting a member's behavior information to a member account in the database module for storage when the behavior information with a UUID integrated is recognized by the signature module; an analysis condition setup module which links the signature module and the behavior analysis module and is used in selecting relevant variables and scopes and configuring analysis-related conditions when the personal data processing and analysis application platform is login according to a secure signature; a report module which links the behavior analysis module, receives analyzed information from the behavior analysis module, and outputs a report with analyzed information transferred; an information configuration module which links the information delivery module and is used in deciding a category of an information demander and preparing information for delivery of the information to a member who has agreed to receive information in advance through the information delivery module.

Specifically, the information separation module classifies personal data into different attribute sector and save the personal data in a member account in the database module for management based on different access privileges.

Specifically, the information separation module separates data reception and configuration information from personal data wherein the data reception and configuration information comprises at least data reception objects, scopes and methods in a member account by which the information delivery module delivers information to a demander.

Specifically, the behavior recording and information request platform further comprises a data access, configuration and authorization module which links the database module and enables two-way authorization for various purposes by a member or the behavior recording and information request platform.

Specifically, the data access, configuration and authorization module allows a member to authorize the behavior recording and information request platform to access, add or modify member-related information; in detail, the data access, configuration and authorization module makes a member authorize the behavior recording and information request platform to execute corresponding information access and employment based on different objects for data applications.

Specifically, the data access, configuration and authorization module renders a UUID as an authentication mechanism by which the behavior recording and information request platform authorizes a member to use resources inside an enterprise or an organization.

Specifically, the member application and login module is used in recording and managing a network location, time and other items related to a member who logins in the personal data processing and analysis application platform.

Specifically, the personal information comprises personal identity information and other reference information wherein the personal identity information is information by which a member's identity is recognized and other reference information is unclassified information or information by which a member's identity cannot he recognized.

Specifically, the information separation module further classifies personal information according to attribute columns and separates information, which is not classified as personal information, into other reference information.

Specifically, the signature module is able to verify a source of behavior information for requisite classification of security when data is transmitted by the data transmission module.

Moreover, the personal data integration and management method comprises steps as follows:

A member enters personal data on an interface of the personal data processing and analysis application platform and applies for a member account wherein the personal data processing and analysis application platform separates the personal data into personal information by which a member's identity is recognized and other reference information by which a member's identity cannot be recognized;

The member who completes an application process receives at least a UUID by which a member's specific behaviors create behavior information that will be integrated with the instantly recorded UUID by the behavior recording and information request platform according to a signature mechanism and transmitted to the personal data processing and analysis application platform for storage;

The behavior recording and information request platform, which relies on a signature mechanism to login the behavior recording and information request platform for configurations of an analytic target, transmits relevant variables to the personal data processing and analysis application platform, and depends on configured analytic target to make statistic analyses of behavior information and other reference information in total or partial member accounts, transform information, and output a report; and

The personal data processing and analysis application platform refers to conditions for information delivery, which have been configured in the behavior recording and information request platform with statistic analyses completed, and delivers information to a demander.

Specifically, the behavior recording and information request platform can be a member, an organization or a research unit.

Specifically, a member can authorize the behavior recording and information request platform, which is either an enterprise or an organization, to access or update the member's information.

Specifically, the behavior recording and information request platform, which is either an enterprise or an organization, can authorize a member to take a UUID as an authentication mechanism for using resources inside the enterprise or the organization.

Specifically, an analytic target configured in the behavior recording and information request platform has no privilege to access and analyze personal information by which a member's identity can be recognized.

Specifically, the behavior information is not always entered from the behavior recording and information request platform but by another information statistics or recording unit based on a specific member account or a notice under help of the behavior recording and information request platform.

Specifically, the personal data processing and analysis application platform can establish a distinct hierarchical tree of a member based on the member's relatives or distinct codes for the member's relationships and further a family tree according to relationships of an immediate family and collaterals automatically.

Specifically, the personal data processing and analysis application platform is able to create an SUID (System User ID) for internal systematic information connections automatically by which at least a UUID (Unique User ID) is created or mapped and employed by a member.

A personal data integration and management system and a method thereof are characteristic of following effects: the system and the method thereof is able to deliver analyzed information or other derivative information to a predetermined demander through a behavior recording and information request platform.

### BRIEF DESCRIPTION OF THE DRAWINGS

FIG. 1 is an architecture block diagram of a personal data integration and management system and a method thereof.

FIG. 2 is a detailed architecture block diagram of a personal data processing and analysis application platform in a personal data integration and management system and a method thereof.

FIG. 3 is a partial architecture block diagram of a behavior recording and information request platform in a personal data integration and management system and a method thereof.

FIG. 4 is a schematic view which illustrates information separation and integration in a personal data integration and management system and a method thereof.

FIG. 5A is a schematic view which illustrates personal data is separated in a personal data integration and management system and a method thereof.

FIG. 5B is a schematic view which illustrates personal data is separated again in a personal data integration and management system and a method thereof.

FIG. 6 is a schematic view which illustrates behavior information in a personal data integration and management system and a method thereof.

FIG. 7 is a flow diagram of a personal data integration and management system and a method thereof.

### DETAILED DESCRIPTION OF THE PREFERRED EMBODIMENTS

The technical contents, features and effects related to a personal data integration and management system and a method thereof are clearly presented in preferred embodiments and accompanying drawings.

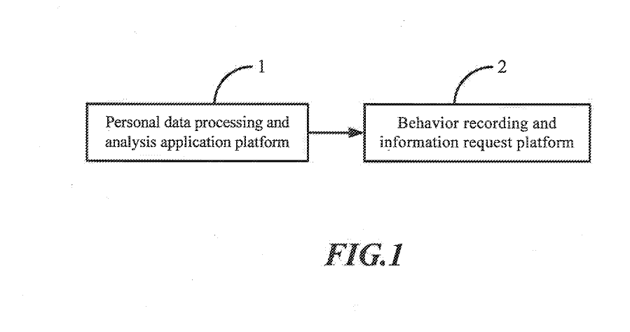

Referring to FIGS. 1, 2 and 3, which illustrate an architecture block diagram of a personal data integration and management system and a method thereof, a partial architecture block diagram of a personal data processing and analysis application platform, and a partial architecture block diagram of a behavior recording and information request platform, respectively. As shown in FIG. 1, the personal data integration and management system comprises a personal data processing and analysis application platform 1 and a behavior recording and information request platform 2, both of which are connected to each other.

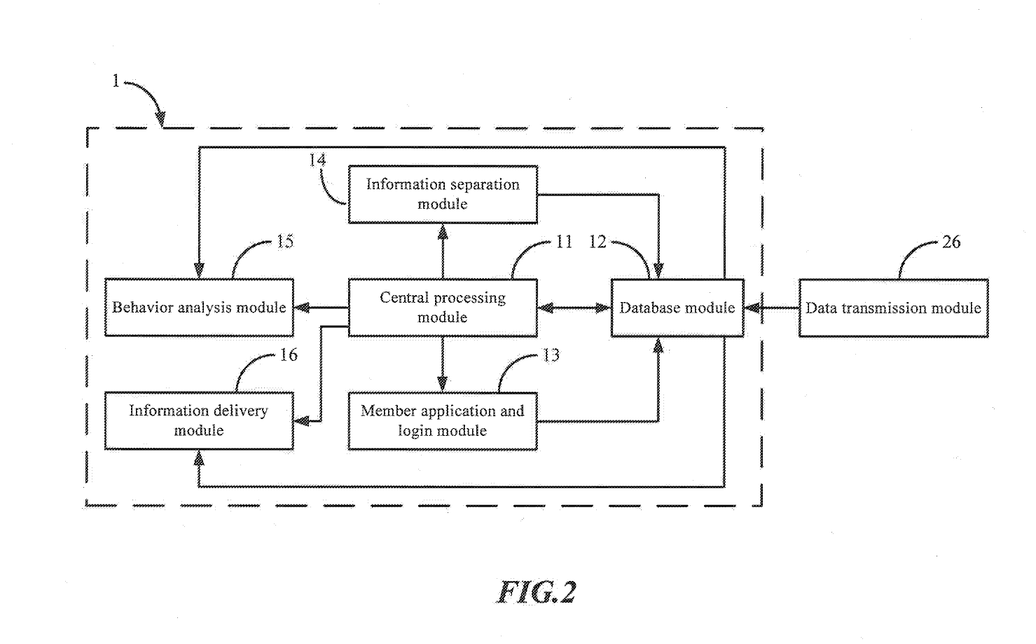

As shown in FIG. 2, the personal data processing and analysis application platform 1 comprise a central processing module 11, a database module 12, a member application and login module 13, an information separation module 14, a behavior analysis module 15 and an information delivery module 16: the personal data processing and analysis application platform 1 allows a member to enter personal data on an interface (written form, homepage, cellphone, Kiosk, etc.) of the member application and login module 13 and apply for a member account; the member application and login module 13 links the central processing module 11; the personal data processing and analysis application platform 1 automatically generates a System User ID (SUID) and at least a Unique User ID (UUID corresponding to SUID, for example, badge ID A1B2C3, chip ID 000AK7C1, etc. in a distinct carrier for applications with different security levels such as record, inquiry, authentication, transaction, etc.) provided to a member from the member application and login module 13 when personal data which is saved in a member account in the database module 12 by the member application and login module 13 is entered by a member.

In addition to nationality, ID number, education, phone number, address, gender, height, weight, etc., other attributes such as family member (for example, parents and children) can be added for relationship connections and development of a hierarchical tree by the personal data integration and management system; a member who completed application of a member account is able to login the personal data processing and analysis application platform 1 to add other personal data by a login authentication mechanism based on a personal account, chip, etc.

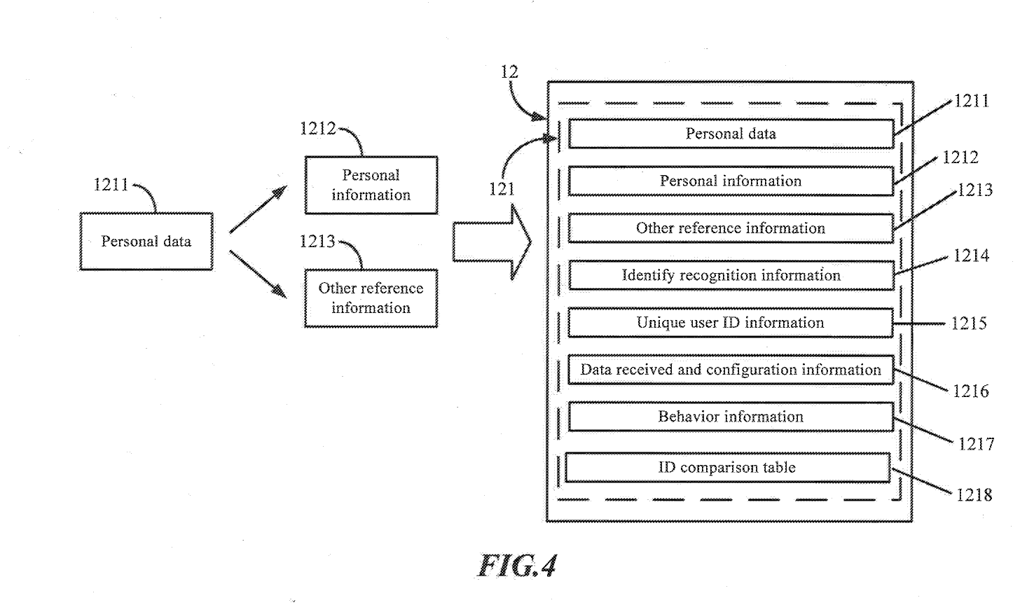

As shown in FIG. 4, personal attribute columns related to entered personal data 1211 are stored separately by the information separation module 14, controlled according to different access privileges, and connected to one another based on SUID. The main items to be separated consist of personal information 1212 (for example, ID number, phone number, address, family member's personal information, etc.) used in recognizing an individual's identify and other reference information 1213 (for example, gender, height, weight, number of family members, etc.) not used in recognizing an individual's identify; these items, which have been separated, should be saved in a member account 121 in the database module 12 and accessed according to distinct security levels given by the information separation module 14.

In addition to the personal information 1212 and the other reference information 1213, identify recognition information 1214 (for example, ID number, system account or other login authentication mechanism), unique user ID information 1215 (an ordinary badge with a unique user ID or an authenticated badge) for external usage, data reception and configuration information 1216, behavior information 1217 and an ID mapping table 1218 are also saved in a member account 121 in the database module 12 wherein the personal information 1212, other reference information 1213, the identify recognition information 1214 and the data reception and configuration information 1216 can be separated from the personal data 1211 directly.

Furthermore, the behavior recording and information request platform 2, which is either an enterprise or an organization, can make a questionnaire survey common in real lives or an online questionnaire survey and transmit questionnaire data with a UUID for external usage integrated to the database module 12 by consent of a respondent after completion of a signature process.

In addition to questionnaire data entered by an enterprise or an organization, behavior information 1217 (for example, subscription behavior, transaction behavior, preference questionnaire, etc.), which is derived from a member's commercial transaction behavior or consumption, is collected and saved in the behavior recording and information request platform 2, integrated with a UUID for recognition of a member's identity in the signature module 21, and transmitted to a member account 121 in the database module 12 from the data transmission module 26 for verification of a data source and requisite classification of security (for example, information available to the general public or some research units only).

The behavior information 1217, which is generated from a questionnaire survey or a commercial transaction behavior, comprises ownership configuration behaviors, system operation and access behaviors, other statistic information, and records based on a UUID. The ownership configuration behaviors mean justified ownership configurations, transfers and accesses. (For example, an individual who possesses bonus points or an ownership for one product recorded with a UUID is able to configure and transfer the justified ownership.)

The system operation and access behaviors expand a member's UUID to an SSO (Single Sign-On) authentication mechanism which reinforces functions of a system log and justifies records for multiple parties; other statistic information is prepared for correct analyses or other purposes. The behavior information 1217 may be information provided by a manufacturer or entered by platform information staff, information received from a government entity (for example, delivery of an ID number of a taxpayer who did not file tax returns and relevant information from the government to the behavior recording and information request platform 2 by which the information is collected in a member account), or statistic information from a research unit, all of which are sources for collection or statistics of information.

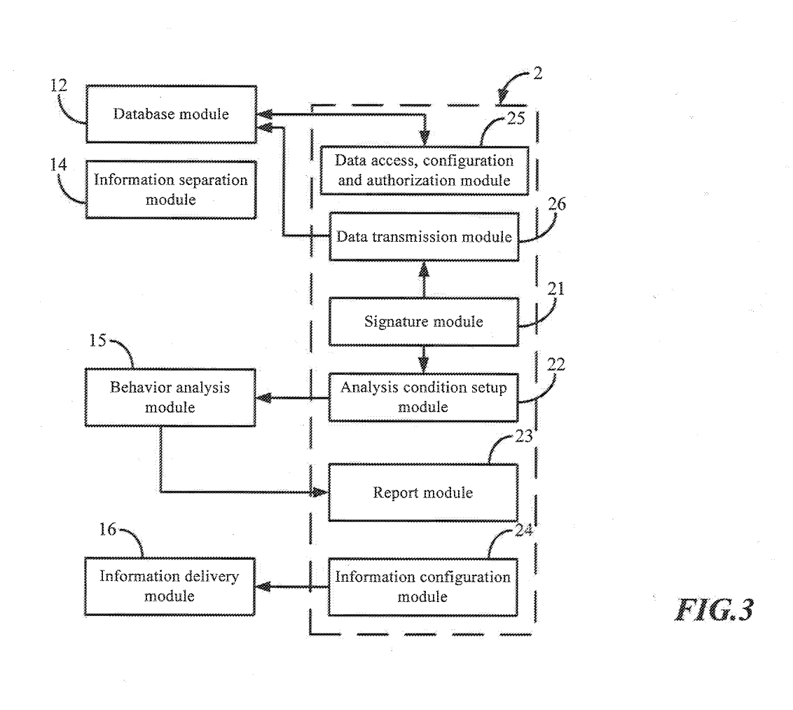

As shown in FIG. 3, the behavior recording and information request platform 2 comprises a signature module 21, an analysis condition setup module 22, a report module 23, an information configuration module 24, a data access, configuration and authorization module 25, and a data transmission module 26. The signature module 21 is used to login the personal data processing and analysis application platform 1 by the behavior recording and information request platform 2 according to a secure signature. The analysis condition setup module 22 is used to select relevant variables and scopes for configurations of analysis conditions when a user's authority is verified by the secure signature; the analysis condition setup module 22 links the behavior analysis module 15, which receives configured analysis conditions, accesses other reference information 1213 and behavior information 1217 of a member account 121 in the database module 12, introduces analysis conditions, other reference information 1213 and behavior information 1217 into a statistic mechanism inside the behavior analysis module 15 for analyses, and deliver analyzed data to the report module 23 from which the analyzed data is transformed to an output report with texts or charts included. (For a user with distinct reading habits, the report module 23 receiving results from the behavior analysis module 15 will create a report in which beneficial results of an enterprise or an organization are presented for effective interpretation.)

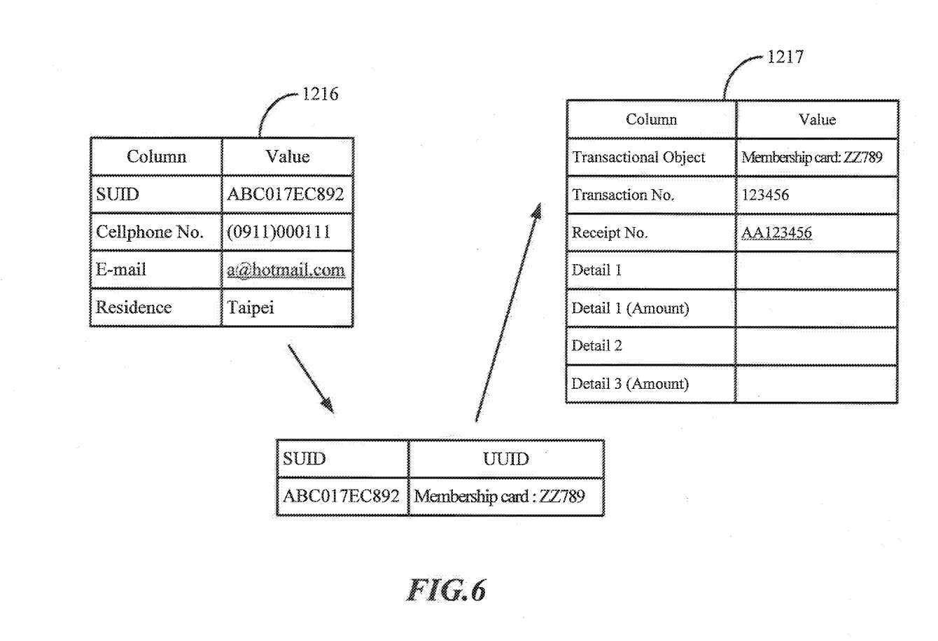

The information configuration module 24 which analyzes the report will find available reference information, configure categories of information receivers (for example, potential consumers, company administrators, researchers, competent authorities, etc.), and prepares information to be received by the information delivery module 16. As shown in FIG. 6, the information separation module 14, which is used to separate personal data 1212 and other reference information 1213, further separates data reception and configuration information 1216 from personal data 1211 so that the information delivery module 16 matches information reception mechanisms between an information sender and an information receiver (for example, specific information from a distinct organization is delivered to a unique e-mail address, information of an urgent sales promotion is transmitted via text messages, etc.) and send information to the outside world.

Moreover, through the data access, configuration and authorization module 25 for two-way authorization, a member will authorizes the behavior recording and information request platform 2, which is either an enterprise or an organization, to access or update a member's information; on the other hand, the behavior recording and information request platform 2, which is either an enterprise or an organization, authorizes a member to use a UUID as an authentication mechanism to take advantage of resources inside the enterprise or the organization. The details are shown as follows:

1. A member authorizes an enterprise or an organization:

A member permits an enterprise or an organization to acquire and use information (for example, personal information of an employee hired by an enterprise or an organization is collected for a specific purpose such as insurance by consent of the employee) or update information automatically (for example, an employee who reports for work or leaves office should agree an enterprise or an organization to modify his/her employment record for no update in the future).

2. An enterprise or an organization authorizes a member:

An enterprise or an organization relying on a UUID mechanism authorizes a member whose identity for accessing resources is recognized to use resources and makes records, for example, inherited platform authentication mechanism and authentication configurations for system operations of an enterprise (organization). The inherited platform authentication mechanism depends on API (Application Program Interface), middleware or system orientation to identify a user; the authentication configurations for system operations of enterprise (organization) which read a member's ID or other necessary information by consent of the member is able to configure privileges in an ID-based operating system (for example, an enterprise's ERP (Enterprise Resource Planning) system, which is being login by a user according to a chip ID, emits a demand of recognizing the user's identity and authority conditions to the behavior recording and information request platform for verification of the ERP system, the behavior recording and information request platform and the user before the ERP system is operated by the user.

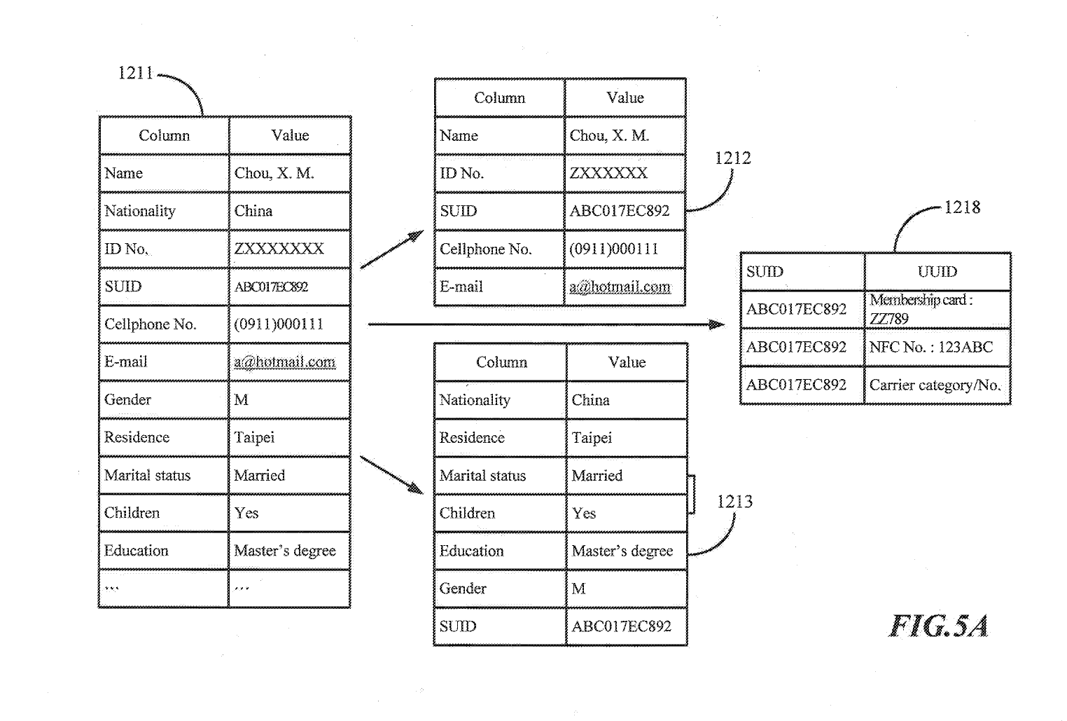

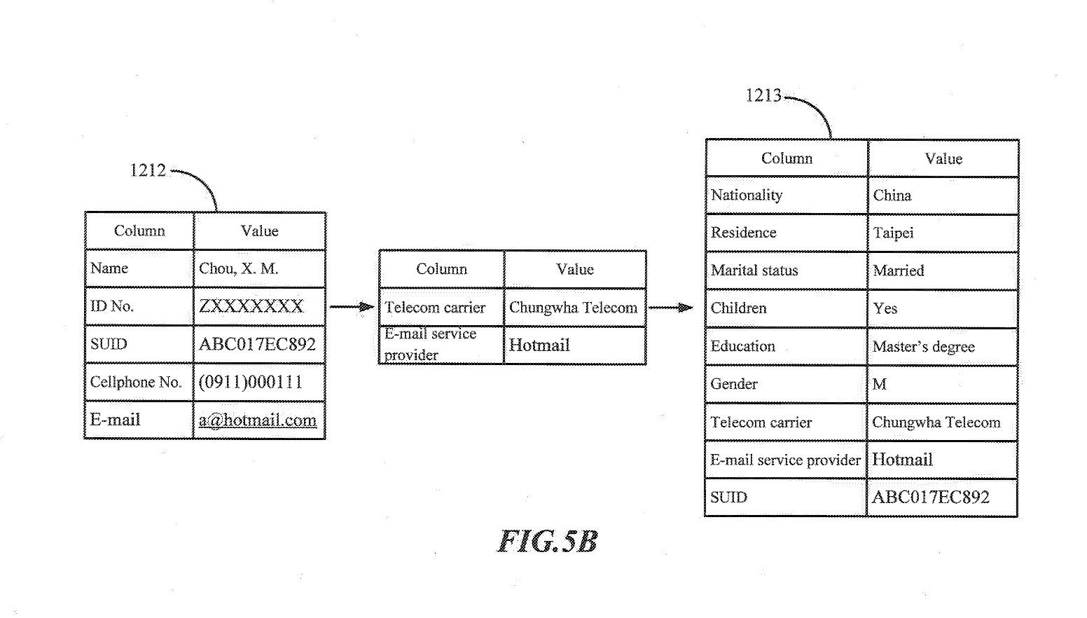

As shown in FIGS. 5A, 5B and 6, which illustrate an example for a personal data integration and management system and a method thereof, a member (Mr. Chou) who is applying for a membership on the homepage provided by the member application and login module 13 enters his personal data (name, nationality, font size (ID card), UUID, mobile phone number, E-Mail, gender, address, marital status, children and education) and the personal data processing and analysis application platform 1 automatically creates a SUID (System User ID linking nationality and font size (ID card)) which further maps at least a UUID record for generation of a UUID (Unique User ID) for external usage only.

As shown in FIG. 5A, the information separation module 14 separates personal data 1211 entered by a member into personal information 1212 (personal specific information such as name, font size (ID card), UUID and E-Mail), other reference information 1213 (information which is not used in recognizing an individual such as nationality, residence, gender, marital status, children, education), and ID mapping table 1218.

Next, according to requirements, the information separation module 14 further separates the personal information 1212 by attribute columns. As shown in FIG. 5B, the personal information 1212 consists of information such as “telecom name” and “e-mail service provider” which is classified into other reference information 1213 because of no risk to disclose an individual's identity.

In addition, behavior information is generated from questionnaire surveys, commercial transaction behaviors, ownership configuration behaviors, system operation and access behaviors, and other statistic information. In the present disclosure, consumer behaviors are taken as an example explained hereinafter because the consumer behavior analysis is well known to everyone. As shown in FIG. 6, behavior information 1217 generated from a member's consumer behavior is saved by the behavior recording and information request platform 2, which logins the personal data processing and analysis application platform 1 for configurations of an analytic target. With an analytic target of “Is the amateur group purchasing merchandises males or females?” set by the patent applicant in a realistic operation and relevant variables transmitted to the behavior analysis module 15, an analysis result is “The amateur group is males.” and a variable-related report is created and transmitted to the behavior recording and information request platform 2.

Next, an enterprise, an organization or a research unit (which is the behavior recording and information request platform itself) refers to the report created by the behavior recording and information request platform 2 for some improvements based on preferences of the female group. The information configuration module 24, which is intended to configure tests of modified product samples for the female group, delivers configurations to the information delivery module 16 that depends on configured contents and objects and transmits information of test results to an individual in a female group inclined to accept modified products.

Configurations for reception of information are divided into configurations of a member and configurations of the behavior recording and information request platform 2: the configurations of a member mean that specific types of information are predetermined by a member or selected by a member who accepted a manufacturer's invitation and distributed according to a member's requirements for information; the configurations of the behavior recording and information request platform 2 are intended to deliver product information or relevant knowledge decided by a manufacturer or a research unit based on conditions of selecting and receiving information set by the member.

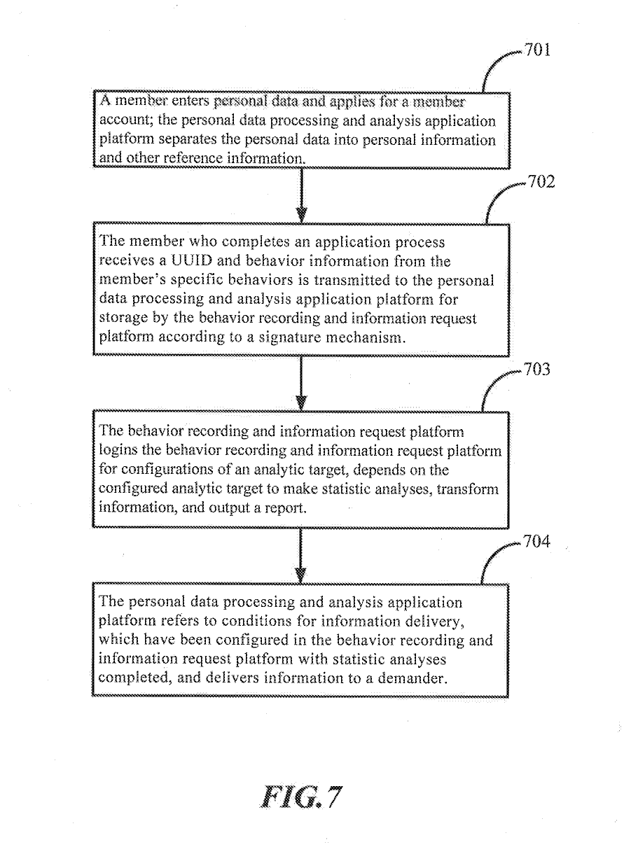

With the above descriptions summarized, the personal data integration and management method comprises following steps, as shown in FIG. 7:

A member enters personal data on an interface of the personal data processing and analysis application platform and applies for a member account wherein the personal data processing and analysis application platform separates the personal data into personal information by which a member's identity is recognized and other reference information by which a member's identity cannot be recognized 701.

The member who completes an application process receives at least a UUID and behavior information from the member's specific behaviors is transmitted to the personal data processing and analysis application platform for storage by the behavior recording and information request platform according to a signature mechanism 702.

The behavior recording and information request platform, which relies on a signature mechanism to login the behavior recording and information request platform for configurations of an analytic target, transmits relevant variables to the personal data processing and analysis application platform, and depends on the configured analytic target to make statistic analyses of behavior information and other reference information in total or partial member accounts, transform information, and output a report 703.

The personal data processing and analysis application platform refers to conditions for information delivery, which have been configured in the behavior recording and information request platform with statistic analyses completed, and delivers information to a demander 704.

A personal data integration and management system and a method thereof in the present disclosure are characteristic of following advantages compared with other common techniques:

1. A personal data integration and management system and a method thereof are competent to filter and classify personal data of members, separate information by which an individual's identity cannot be recognized, analyze behavior information with the separated information integrated, and allow an enterprise, an organization or a research unit to access analyzed data for effective applications of information.

2. A personal data integration and management system and a method thereof are characteristic of an information receiver's category filtered and configured by a member, an enterprise or an organization based on analyzed meaningful information for information preparation and delivery; this mechanism will contribute to information validity which protects a member to receive effective information rather than intrusive spam.

3. A personal data integration and management system and a method thereof provide a member with a UUID (Unique User ID) by which only information unrelated to a member's identity is accessed and ensures data security of a member because of neither a member's real identity nor relevant information disclosed.

4. With records related to a specific product's unique ID integrated, a personal data integration and management system and a method thereof are able to declare and justify the ownership of an object and record ownership transfer or declaration of an object (for example, digital music, e-book, bonus point, etc.); a personal data integration and management system and a method thereof contribute to centralization of members' information and information filtering in contrast to manufacturers' respective existing information systems which should be login for configurations separately.

5. In a personal data integration and management system and a method thereof, the personal information by which a member's identity is recognized is accessed and modified by a member rather than an enterprise, an organization or a research unit (behavior recording and information request platform); if necessary, a member can authorize an enterprise, an organization or a research unit to access personal information by which a member's identity is recognized within a specific range by consent of the member and each of the member, the enterprise, the organization and the research unit can check a query log for the personal information.

6. Except analyzed results, personal data related to an analyzed sample cannot be accessed by an enterprise, an organization or a research unit (the behavior recording and information request platform) which made the analyses.

What is claimed is:

1. A personal data integration and management system for management of applications of members' personal data, comprising:
a personal data processing and analysis application platforming a behavior recording and information request platform and comprising:
a central processing module which regulates and controls operations of the personal data processing and analysis application platform;
a database module which links the central processing module and stores member-related information in a member account;
a member application and login module which links the central processing module and the database module, is employed by a member to login the personal data processing and analysis application platform, enter personal data and apply for a member account, provides the member with a Unique User ID (UUID), and stores personal data in a member account in the database module;
an information separation module linking the central processing module and the database module and separating personal data into at least two types of information, personal information and other reference information, which is controlled according to different access privileges;
a behavior analysis module which links the central processing module and the database module and conducts statistical analyses of other reference information and behavior information related to a member account in the database module for delivery of the analyzed information to a report module in the behavior recording and information request platform;
an information delivery module which links the central processing module and the database module and sends appropriate information to a demander;
a behavior recording and information request platform linking the personal data processing and analysis application platform and comprising at least:
a signature module which allows the behavior recording and information request platform to login the personal data processing and analysis application platform by a secure signature;
a data transmission module which links the signature module as well as the database module in the personal data processing and analysis application platform and is used in transmitting a member's behavior information to a member account in the database module for storage when the behavior information with a UUID integrated is verified by the signature module;
an analysis condition setup module which links the signature module and the behavior analysis module and is used in selecting relevant variables and scopes and configuring analysis-related conditions when the personal data processing and analysis application platform is login according to a secure signature;
a report module which links the behavior analysis module, receives analyzed information from the behavior analysis module, and outputs a report with analyzed information transferred; and
an information configuration module which links the information delivery module and is used in deciding a category of an information demander and preparing information for delivery of the information to a member who had agreed to receive information in advance through the information delivery module.

2. A personal data integration and management system as claimed in claim 1 wherein:
the information separation module classifies personal data into different attribute sector and save the personal data in a member account in the database module for management based on different access privileges.

3. A personal data integration and management system as claimed in claim 1 wherein:
the information separation module separates data reception and configuration information from personal data wherein the data reception and configuration information comprises at least data reception objects, scopes and methods in a member account by which the information delivery module delivers information to a demander.

4. A personal data integration and management system as claimed in claim 1 wherein:
the behavior recording and information request platform further comprises a data access, configuration and authorization module which links the database module and enables two-way authorization for various purposes by a member and the behavior recording and information request platform.

5. A personal data integration and management system as claimed in claim 4 wherein:
the data access, configuration and authorization module allows a member to authorize the behavior recording and information request platform to access, add or modify member-related information.

6. A personal data integration and management system as claimed in claim 4 wherein:
the data access, configuration and authorization module makes the behavior recording and information request platform authorize a member to take a UUID as an authentication mechanism for using resources inside an enterprise or an organization.

7. A personal data integration and management system as claimed in claim 1 wherein:
the member application and login module is used in recording and managing a network location, time and other items related to a member who logins in the personal data processing and analysis application platform.

8. A personal data integration and management system as claimed in claim 1 wherein:
the personal information comprises personal identity information and other reference information wherein the personal identity information is information by which a member's identity is recognized and other reference information is unclassified information or information by which a member's identity cannot be recognized.

9. A personal data integration and management system as claimed in claim 8 wherein:
the information separation module further classifies personal information according to attribute columns and separates information which is not classified as personal information into other reference information.

10. A personal data integration and management system as claimed in claim 1 wherein:
the signature module is able to verify a source of behavior information for requisite classification of security when data is transmitted by the data transmission module.

11. A personal data integration and management method, comprising steps:
A member enters personal data on an interface of the personal data processing and analysis application platform and applies for a member account wherein the personal data processing and analysis application platform separates the personal data into personal information by which a member's identity is recognized and other reference information by which a member's identity cannot be recognized;
The member who completes an application process receives at least a UUID by which a member's specific behaviors create behavior information that be integrated with the instantly recorded UUID by the behavior recording and information request platform according to a signature mechanism and transmitted to the personal data processing and analysis application platform for storage;
The behavior recording and information request platform, which relies on a signature mechanism to login the behavior recording and information request platform for configurations of an analytic target, transmits relevant variables to the personal data processing and analysis application platform and depends on configured analytic target to make statistic analyses of behavior information and other reference information in total or partial member accounts, transform information, and output a report; and
The personal data processing and analysis application platform refers to conditions for information delivery, which have been configured in the behavior recording and information request platform with statistic analyses completed, and delivers information to a demander.

12. A personal data integration and management method as claimed in claim 11 wherein:
the behavior recording and information request platform can be a member, an organization or a research unit.

13. A personal data integration and management method as claimed in claim 12 wherein:
a member can authorize the behavior recording and information request platform, which is either an enterprise or an organization, to access or update the member's information.

14. A personal data integration and management method as claimed in claim 11 wherein:
the behavior recording and information request platform, which is either an enterprise or an organization, can authorize a member to take a UUID as an authentication mechanism for using resources inside the enterprise or the organization.

15. A personal data integration and management method as claimed in claim 11 wherein:
an analytic target configured in the behavior recording and information request platform has no privilege to access and analyze personal information by which a member's identity is recognized.

16. A personal data integration and management method as claimed in claim 11 wherein:
the behavior information is not always entered from the behavior recording and information request platform but by another information statistics or recording unit based on a specific member account or a notice under help of the behavior recording and information request platform.

17. A personal data integration and management method as claimed in claim 11 wherein:
the personal data processing and analysis application platform can establish a distinct hierarchical tree of a member based on the member's relatives or distinct codes for the member's relationships and further a family tree according to relationships of an immediate family and collaterals automatically.

18. A personal data integration and management method as claimed in claim 11 wherein:
the personal data processing and analysis application platform is able to create an SUID (System User ID) for internal systematic information connections automatically by which at least a UUID (Unique User ID) is created or mapped and employed by a member.
